(19) United States
(12) Patent Application Publication
(10) Pub. No.: US 2003/0121982 A1
(43) Pub. Date: Jul. 3, 2003

(54) Kiosk having leverageable scanner

(75) Inventor: Peter R. Charpentier, Suwanee, GA (US)

Correspondence Address: PAUL W. MARTIN, LAW DEPARTMENT, WHQ-5E, 1700 S. PATTERSON BLVD., DAYTON, OH, 45479-0001, US

(73) Assignee: NCR Corporation

(21) Appl. No.: 10/034,537

(22) Filed: Dec. 27, 2001

(51) Int. Cl. G06K 7/10

(52) U.S. Cl. 235/472.01

(57) ABSTRACT

A retail terminal or kiosk has a scanner that is configured and/or adapted to be in a fixed position for an unassisted mode of operation, and removable for an assisted mode of operation. The scanner is part of a module that is releasably mounted to the housing of the kiosk. The module includes a preferably releasable locking attachment mechanism that permits the scanner to be fixedly attached to the kiosk and removed therefrom. The single-device kiosk has a fixed scanner in an optimum position for self-service that can be removed and used apart from the kiosk when in an assisted mode. In this manner the security and usability of self-service is maintained while the flexibility of assisted service is available as an option by leveraging the same hardware for both.

### BACKGROUND

1. Field of the Invention

The present invention relates generally to retail terminals that have and utilize scanners and, more particularly, to retail terminals that are operative in an assisted mode of operation and an unassisted mode of operation.

2. Background Information

In retail and non-retail businesses, various types of computer-driven or computer-operated machines or devices are currently in use. One type of such device is the retail terminal. The retail terminal comes in many forms depending on its intended use. Particularly, a retail terminal may be designed and used as an assisted retail terminal (e.g. an assisted checkout terminal or point-of-sale terminal), or may be designed and used as an unassisted retail terminal (e.g. a self-checkout terminal).

The assisted retail terminal typically has a number of components that are situated about a non-movable platform (e.g. a counter or desk). In addition to such components as a display, payment acceptors, and the like, the assisted retail terminal also includes a scanner. The scanner is either fixed to various components of the assisted retail terminal such as a housing or the like, or the scanner is a separate module that is coupled to the assisted retail terminal via a cord or the like.

Another form of a retail terminal device is a kiosk. Typically, the kiosk is utilized as an unassisted retail terminal. The kiosk is a small and compact device that has a housing supporting an integral display and payment acceptor. In addition, if the kiosk has a scanner, the scanner is fixed to the kiosk housing (i.e. the scanner does not move).

Because of the variety of business devices available, businesses are asking for one solution and/or device to handle assisted service (point-of-sale) and unassisted (self-service) requirements. Businesses are also looking for both increased value and use from such devices. Physical space is an additional cost factor driving the need for devices having multi-purpose use. In summation, businesses now want devices that are flexible and address multiple business needs for a particular location.

As described above, both the unassisted retail terminal and the typical kiosk (unassisted retail terminal) do no provide the needed flexibility to be used in both assisted and unassisted retail terminal situations. The assisted retail terminal is not suited for unassisted use. As well, the kiosk may not be suited for some applications. Since the kiosk is typically mounted to a location, the kiosk cannot scan large items that do not fit beneath the fixed position scanner. Further the kiosk does not allow the scanner to be removed in order to scan large items that do not fit beneath the fixed scanner.

It would thus be advantageous to have a kiosk that can be utilized in both an assisted mode of operation and unassisted mode of operation.

What is therefore needed is a kiosk that overcomes one or more of the above-mentioned drawbacks. What is further needed, in general, is a more versatile kiosk.

### SUMMARY

The subject invention is a kiosk having a scanner that is detachable from a kiosk housing and useable for kiosk transactions when attached and detached. The scanner is retained by a scanner housing that is releasably coupled to and/or part of the kiosk housing. The scanner housing is also able to be locked to the kiosk housing. When the scanner is attached to the kiosk housing, the kiosk and/or scanner is operative in an unassisted mode of operation. When scanner is detached from the kiosk housing, the kiosk and/or scanner is operative in an assisted mode of operation.

The subject invention thus combines the benefits of a fixed scanner interface for self-service (unassisted mode) with the flexibility of a moveable scanner used in an assisted mode. The subject invention allows a kiosk to be used for both an assisted mode of operation and an unassisted mode of operation. The subject invention allows the scanner of a kiosk to be leveraged for use in both assisted and unassisted modes of operation. In this manner, a point-of-sale operator can leverage the same scanner used in the self-service mode for the assisted mode, while the self-service user can only use the scanner in a fixed and securely mounted position. Additionally, when in a self-service mode, the scanner of the kiosk is in a human factors recommended fixed position.

In one form, subject invention is a kiosk having a housing, processing circuitry/logic within the housing, a display supported by the housing and in communication with the processing circuitry/logic, and a scanner in communication with the processing circuitry/logic. The scanner is detachably mounted to the housing and operative in both the attached and detached modes.

In another from, the subject invention is a kiosk having a housing, a processor disposed within the housing, a display supported by the housing, and a scanner detachably mounted to the housing. The kiosk is operative in a first mode wherein the scanner is detached from the housing, and in a second mode wherein the scanner is fixed relative to the housing.

### BRIEF DESCRIPTION OF THE DRAWINGS

FIG. 1 is a perspective view of an exemplary kiosk embodying the subject invention;

FIG. 2 is an exploded perspective view of the exemplary kiosk of FIG. 1;

FIG. 3 is a perspective view of the exemplary kiosk of FIG. 1; and

FIG. 4 is a block diagram of the exemplary kiosk.

Corresponding reference characters indicate corresponding parts throughout the several views.

### DETAILED DESCRIPTION OF THE INVENTION

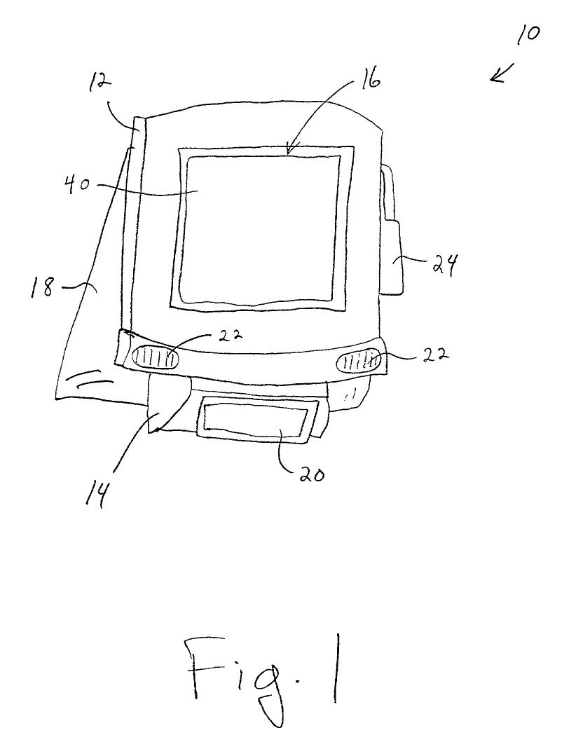

Referring to FIG. 1, there is depicted an exemplary kiosk generally designated 10. The kiosk 10 is representative of a type of retail terminal that is typically utilized for unassisted retail operation and thus is operative as depicted in an unassisted mode. The kiosk 10 includes a display housing 12 that retains and/or supports a display 16 having a touch-screen 40. The display 16 may be any type or kind of display, but is preferably and LCD display. The touch-screen 40 is overlaid on the display and is operative in a normal manner. Thus, information that is shown on the display 16 may be utilized as touch-screen objects, choices, selections, or the like.

The kiosk 10 further includes speakers 22 or other types of audio reproduction devices that are integral with the housing 12. The speakers 22 are operative to provide audio as appropriate. The housing 12 also supports a payment acceptor or device 24. The payment device 24 is operative to read information from a card such as a magnetic stripe type card, a smart card, or the like. In this manner, the payment device 24 allows a user to pay for a purchase made at the kiosk. The payment device 24 also allows a user to obtain information such as account status, from the data on the card used in the payment device 24.

The kiosk 10 also includes a main housing 18 that operatively supports the display housing 12 (and thus the display 16, the speakers 22, and the payment device 24). The main housing 18 is adapted to be mounted to a wall, post or the like or to be mounted on a table, counter or the like.

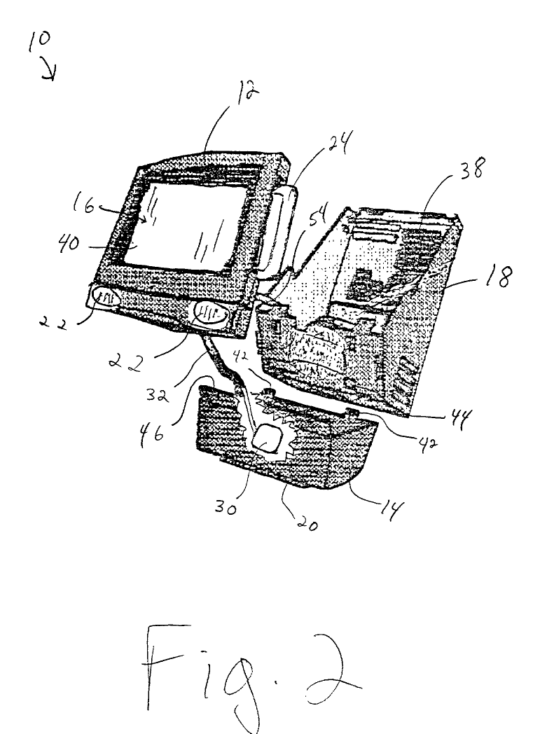

The kiosk 10 includes a scanner housing 14 that is mounted to the housing 18 adjacent the display housing 12. The scanner housing 14 houses a scanner or scanning unit 30 (see FIG. 2). The scanner housing 14 has a scanner window 20 that allows the scanner 30 to operate. In accordance with an aspect of the subject invention, the scanner housing 14 (and thus the scanner 30 therein) is detachably connected to the housing 18.

Referring to FIG. 2, as aspect of the subject invention will be discussed. In FIG. 2, there is depicted the kiosk 10 in an exploded form. The housing 18 includes a processor, processing circuitry/logic, and/or the like 38. The housing 18 also supports various other features/components as are appropriate for a kiosk 10 but which are not necessary for the understanding of the subject invention. The main housing 18 is configured to receive and retain the display housing 12 thereon. The components supported by the housing 12 are in communication with the processor 38 via a communication cable 54. The communication cable 54 is operative via a plurality of conductors (e.g. wires) or via a single conductor as appropriate to provide communication between the various components of the housing 12 and the processor 38.

The scanner housing 14 includes a scanner or scanning unit/module 30. The scanner 30 is a typical scanner that is operative to read indicia such as bar codes and the like and provide the obtained (read) information to the processor 38 and/or other components of the kiosk as appropriate. In accordance with an aspect of the subject invention, the scanner housing 14 (and thus the scanner 30) is coupled to the housing 12 (or while not shown, alternatively, coupled to the housing 18) via a tether 32 or the like. The tether 32 may be retractable. As well, the tether 32 includes communication lines for providing data obtained by the scanner 30 to the processor 38 (and other components as necessary). The scanner housing 14 (and thus the scanner 30) are detachable from the kiosk 10 and useable in a detached form.

The housing 18 includes slots 44 that are configured to receive the tabs 42 of the scanner housing 14. The scanner housing 14 also includes a rim 446 that connects with the display housing 12 and/or the housing 18. Of course, other manners or ways of releasably attaching the scanner housing 14 to the housing 18 (and/or the housing 12) may be used. The manner of attachment, however, must allow the scanner housing 14 to be securely fixed to the kiosk 10 (when thus in an unassisted mode of operation) and to be releasable by a user (when thus in an assisted mode of operation). While not particularly depicted, it should be appreciated that the tether 32 is of adequate length to allow a user to use the scanner 30 in a “free form” manner. This allows the scanner 30 to transition from an assisted-service device to a self-service (unassisted) device by a store employee or the like in a matter of minutes. In the assisted-service mode the scanner 30 is movable. In the unassisted-service mode, the scanner is fixed relative to the kiosk 10.

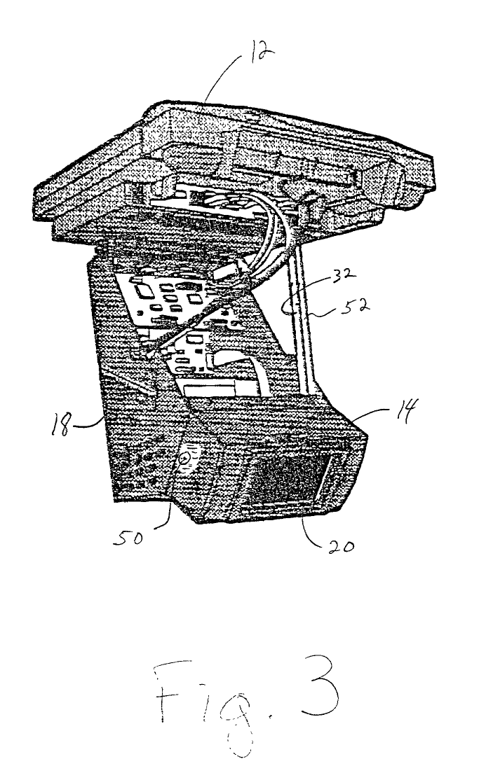

In FIG. 3, the kiosk 10 is depicted assembled but in an open position. Particularly, the housing 12 is shown pivotally attached to the housing 18 and raised. A strut or the like 52 is provided that allow the display housing 12 to pivot relative to the housing 18. This may be necessary for service and/or the like.

As shown in FIG. 3, the scanner housing 14 may include a locking mechanism (here embodied as a lock 50). The locking mechanism 50 is releasable to allow the scanner housing 14 (scanner 30) to detach from the remainder of the kiosk 10. The locking mechanism also prevents the scanner housing (scanner 30) from being released in appropriately.

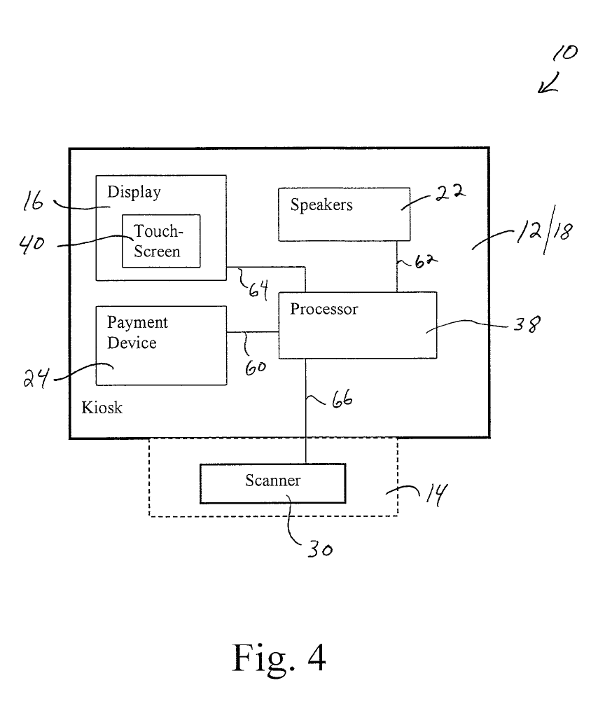

In FIG. 4, a block diagram of the exemplary kiosk 10 is depicted. The housings 12 and 18 house the processor, processing circuitry/logic, or the like 38. The payment device 24 and the speakers 22 are in communication with the processor 38 via communication lines 60 and 62 respectively. The display 16 and associated touch-screen 40 are also in communication with the processor 38 via a communication line 64. The display 16, touch-screen 40, speakers 22, and payment device 24 are all generally under control of the processor 38. The processor 38 is typically under control of program instructions that are stored internally therein, or in memory (not shown) that is associated with the processor 38. Operation of the display 16, touch-screen 40, speakers 22, and payment device 24 are standard for such kiosks.

As indicated by the dashed lines, the scanner housing 14 is detachably coupled to the housings 12/18. The scanner 30 is supported in the scanner housing 14 and is in communication with the processor 38 via a communication line 66. The communication line 66 is preferably part of the tether 32 (see FIG. 2). As such the communication line 66 along with (or as part of) the tether 32 may be retractable, coiled, or the like. In this manner, when the scanner 30 (scanner housing 14) is detached from the housings 12/18, cord management is not a problem.

It should be appreciated that a kiosk (including the present kiosk 10) typically has more components than shown in FIG. 4. However, the block diagram of FIG. 4 is simplified to show those main components of the kiosk 10 and of typical kiosks.

While this invention has been described as having a preferred design, the subject invention can be further modified within the spirit and scope of this disclosure. This application is therefore intended to cover any variations, uses, or adaptations of the subject invention using its general principles. Further, this application is intended to cover such departures from the present disclosure as come within known or customary practice in the art to which this invention pertains and that fall within the limits of the appended claims.

What is claimed is:

1. A kiosk comprising:
a housing;
processing circuitry/logic within said housing;
a display supported by said housing and in communication with said processing circuitry/logic; and
a scanner in communication with said processing circuitry/logic and detachably mounted to said housing.

2. The kiosk of claim 1, further comprising a scanner housing supporting said scanner, said scanner housing being detachable mounted to said housing.

3. The kiosk of claim 2, wherein said scanner housing is coupled to said housing via a tether.

4. The kiosk of claim 3, wherein said tether is retractable.

5. The kiosk of claim 2, further comprising a locking mechanism associated with said scanner housing and operative to lock said scanner housing to said housing.

6. The kiosk of claim 1, further comprising a display housing supporting said display, said display housing supported by said housing.

7. A kiosk comprising:
a housing;
a processor disposed within said housing;
a display supported by said housing and in communication with said processor; and
a scanner detachably mounted to said housing and in communication with said processor;
said kiosk operative in a first mode wherein said scanner is detached from said housing, and in a second mode wherein said scanner is fixed relative to said housing.

8. The kiosk of claim 7, further comprising a scanner housing supporting said scanner, said scanner housing being detachably mounted to said housing.

9. The kiosk of claim 8, wherein said scanner housing is coupled to said housing via a tether.

10. The kiosk of claim 9, wherein said tether is retractable.

11. The kiosk of claim 8, further comprising a locking mechanism associated with said scanner housing and operative to lock said scanner housing to said housing.

12. The kiosk of claim 7, further comprising a display housing supporting said display, said display housing supported by said housing.

13. A kiosk comprising:
a first housing;
processing circuitry disposed within said first housing;
a touch-screen display supported by said first housing and in communication with said processing circuitry;
a second housing detachably coupled to said first housing; and
a scanner disposed in said second housing and in communication with said processing circuitry;
said scanner operative in both an attached and a detached mode.

14. The kiosk of claim 13, wherein said second housing is detachable coupled to said first housing via a tether.

15. The kiosk of claim 14, wherein said tether is retractable.

16. The kiosk of claim 14, further comprising a lock associated with said second housing and operative to lock said second housing to said first housing.
